(19) United States
(12) Patent Application Publication
(10) Pub. No.: US 2019/0303977 A1
(43) Pub. Date: Oct. 3, 2019

(54) MAXIMIZING EMOTIONAL TARGETING IF IN-GAME ADVERTISING ON MOBILE PLATFORMS

(71) Applicant: Sayollo Media LTD., Rehovot (IL)

(72) Inventors: Eitan Norel, Ashdod (IL); Yonatan Attias, Ashdod (IL)

(73) Assignee: Sayollo Media LTD., Rehovot (IL)

(21) Appl. No.: 16/372,444

(22) Filed: Apr. 2, 2019

Related U.S. Application Data
(60) Provisional application No. 62/651,302, filed on Apr. 2, 2018.

(51) Int. Cl. G06Q 30/02; A63F 13/61; G06N 20/00

(52) U.S. Cl. CPC G06Q 30/0271; G06N 20/00; A63F 13/61; G06Q 30/0267

(57) ABSTRACT

The disclosure is directed to systems and methods for maximizing and/or optimizing emotional targeting of virtual, mobile, in-game advertisings. In particular, the present disclosure is directed to system and methods using machine learning to upload and virtually position directed advertising in a game platform operating on a mobile computing device.

### RELATED APPLICATION

The application claims priority from U.S. Provisional Application Ser. No. 62/651,302, filed on Apr. 2, 2018, which is incorporated herein by reference for all purposes.

### COPYRIGHTS NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### BACKGROUND OF THE INVENTION

The present disclosure relates to systems and methods for maximizing and/or optimizing emotional targeting of virtual, mobile, in-game advertisings. In particular, the present disclosure relates to system and methods using machine learning to upload and virtually position directed advertising in a game platform operating on a mobile computing device.

In playing computer games game typically causes the gamer to go through a wide range of emotions—from crushing disappointment, through frustration, to relief, to elation. Knowing when these gamers are experiencing these emotions provides the emotional targeting of advertising. For example, when a player gets a new high-score, achieves a personal best or gets stuck on a level and needs to be rescued. Establishing an emotional and memorable connection can produce engagement rates that are substantially higher. However, it remains important to be able to position the advert as an integral part of the game environment, in a way that would seem natural to the gamer.

Furthermore, in 2016, for the first time mobile gaming revenues surpassed the money generated by console and PC games, with games from tablets and smartphones generating about $37 billion in revenues, compared with about $32 billion for PC games and about $29 billion in revenues for console games. The numbers increased substantially in 2017, with smartphone and tablet gaming growing 19% year over year, generating over $46 billion, or 42% of the global market.

Simultaneously, by 2019, digital mobile advertising is expected to represent 72% of all digital ad spending. However, this trend is taking place in a market where 70% of responders indicate they do not like mobile advertising and the number of hours spent on non-voice (e.g., mobile games) media is ever increasing.

These and other aspects are addressed by the following systems and methods maximizing and/or optimizing emotional targeting of virtual, mobile, in-game advertisings.

### SUMMARY OF THE INVENTION

Disclosed, in various embodiments, are system and methods using machine learning to upload and virtually position directed advertising in a game platform operating on a mobile computing device based on emotional target event.

In an embodiment, provided herein is a method for maximizing a player's emotional targeting of in-game advertisement in a computerized mobile communication device, implemented in a computerized system comprising: the computerized mobile communication device in communication with a network, a game development framework with an add-on program configured to enable addition and location of a remotely stored advertising, in real time into the game; a game application in communication with the development framework, having an advertising media player, the game application and advertising media player configured to be executed in the computerized mobile communication device, wherein the game application is in communication with the game development framework; and a backend advertising management server in communication with the game application and the remotely stored advertising, the method comprising: establishing a player profile; based on the player profile, in real time, determining an advertisement to be presented; through a network and using the backend advertising management server, retrieving the remotely stored advertising to be presented; delivering the advertising to the advertising media player; based on an emotional target event in the game, locating in real-time an object configured to display the advertising to be presented; and upon occurring of the emotional target event, using the advertising media player, displaying the advertisement on the object.

These and other features of the systems and methods using machine learning to upload and virtually position directed advertising in a game platform operating on a mobile computing device will become apparent from the following detailed description when read in conjunction with the drawings, which are exemplary, not limiting.

### BRIEF DESCRIPTION OF THE FIGURES

For a better understanding of the systems and methods using machine learning to upload and virtually position directed advertising in a game platform operating on a mobile computing device, with regard to the embodiments thereof, reference is made to the accompanying drawings, in which:

FIG. 1, is a schematic illustrating an embodiment of the interrelations between the components of the systems; and

FIG. 2, is a schematic illustrating of an embodiment of the various ways of deployment of embodiments of the methods and systems described.

### DETAILED DESCRIPTION OF THE PREFERRED EMBODIMENTS

Provided herein are embodiments of systems and methods using machine learning to upload and virtually position directed advertising in a game platform operating on a mobile computing device. In other words, the method and systems disclosed and claimed herein are configured to enable “On-the-fly”, real-time placement of ads in virtual mobile game environment, and integrate the ads to the game scene, making appear as an integral part of the game.

It is noted, that unlike currently available system, the ads do not reside on the client device, but rather are stored on a backend ad management server, which can be in communication with the brand management server.

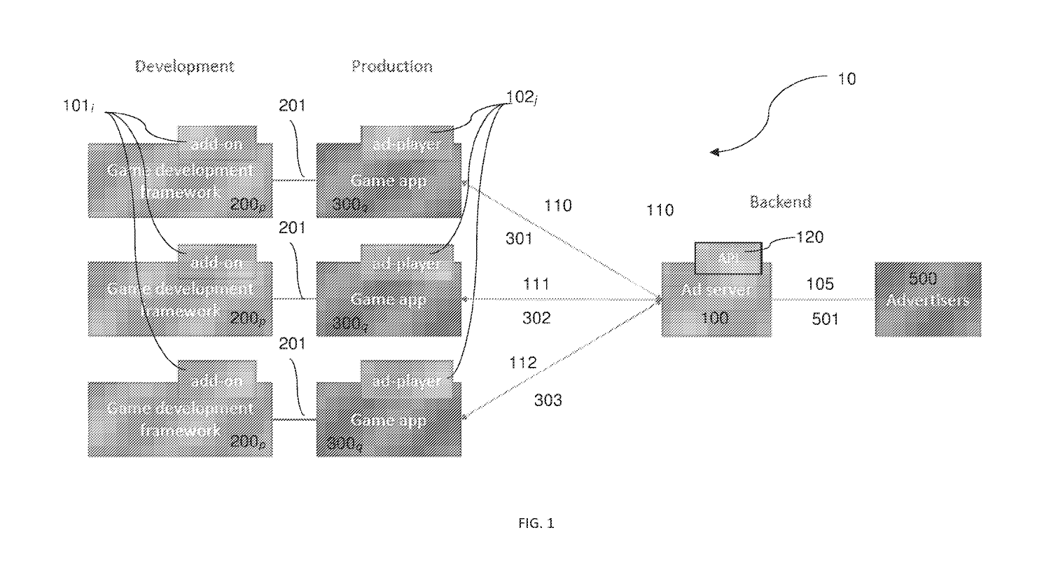

The systems and methods described herein can be used to provide in-game advertising in real time. As illustrated in FIG. 1, the system comprises various modules and interconnected entities. Assumption is made that the (mobile) game developer can and does remain in contact with the mobile game platform. Whether to provide updates, features, rewards and the like. Game development framework 200ₚ, refers in an embodiment, to any game development entity and can include an add-on 101i, provided in an embodiment by the entity controlling backend ad management server 100.

As used herein, the term “add-on” is used to refer to computing instructions configured to extend the functionality of a computer program, where the add-on is developed specifically for the computer program. An add-on may be developed by a third-party or by the developer of the mobile game. Add-ons are sometimes referred to as “plug-ins.”

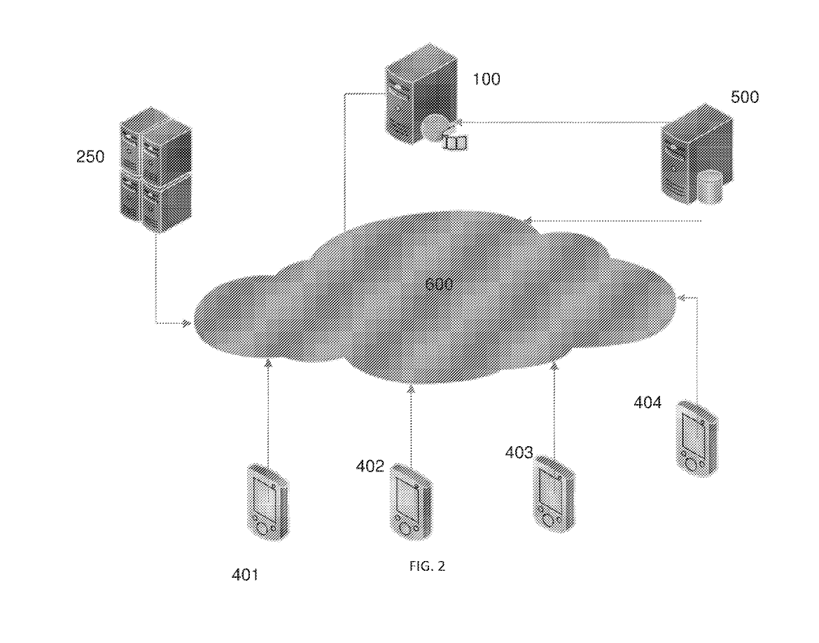

In an embodiment, “Add-ons” refer to sets of computing instructions that are used to extend the functionality of or otherwise augment the mobile game program. Add-ons 101_{f}, can be used in a wide variety of ways. For example, add on 101ᵢ can be a plurality of add-ons that can be used to enhance game play for example, to resize and ad to identify a flat surface within the game scene, another add-on that can resize the ad rendering to coincide with the identified flat surface, with other add-ons that adds a billboard and rounds the corners of that billboard or determines based on the available virtual scene, what size to make such a billboard. Yet other add-on to select the location and positioning of the ad (whether a billboard or otherwise). In an embodiment, add on 101ᵢ can be configured to, when executed, cause a processor (whether game processor, or the device processor) to: wirelessly connect with computerized mobile communication device (see e.g., 401, 402, 403, 404, FIG. 2); control an operation of the game on computerized mobile communication device 401, 402, 402, 404; access game progress files stored on computerized mobile communication device 401, 402, 402, 404; and perform machine learning to discern a player-specific emotional target event engagement rate. The player-specific emotional target event engagement rate can be determined based on at least one of: rate of movement of the computerized mobile communication device, pressure on the computerized mobile communication device, eyeball tracking, and heartrate. Other engagement rates can be discerned from feedback requested directly from the game player or other feedback means used by the game development framework.

Furthermore, Add-on data is data included with, generated or organized by an add-on. For example, in the mobile game application, add-on data may include at least one of the locations of objects within a game, emotional targeting events, highest personal score, search history (to assist in selecting an ad from the ad database), timer, characteristics of non-player characters, maps, historical information, and (emotional) event timing information.

As illustrated in FIG. 1, in addition to add-on 101ᵢ on the game developer framework 200ₚ, an additional add-on 102ⱼ can be installed in gaming application 300_{q} itself. Add-ons 102ⱼ, can be configured to enable at least one of: managing ad playing (in other words, actuating the billboard frame in the scene using for example, the mobile device integral media player), ad-view monitoring (in other words, gauging engagement with the ad) and sending 301, 301, 303 event statistics and feedback to Backend Ad management Server 100.

In an embodiment, delivery (streaming) and displaying the in-game advertising can be done using the computerized mobile device's integral media player, or a media player provided by the entity controlling the Backend Ad management Server 100. As used herein, the term media player is defined as a platform for delivering media to a user through a user interface.

In an embodiment, Backend Ad management Server 100 is configured to and delivers video ads to Game Apps having thereon the proper add-on(s), creates usage statistics. In an embodiment, where a dedicated game app media player is providing by the entity controlling the Backend Ad management Server 100, rather than using the media player integrated (either as an app such as VLC) on the computerized mobile communication device, or that of the game app provider, the Backend Ad management Server 100 can further comprise an application programming interface (API) 120, configured to manage the provided media player. API 120 can, for example allow the program residing on Backend Ad management Server 100 to communicate with computerized mobile communication device (see e.g., 401, 402, 403, 404, FIG. 2), through network 600. The add-on component 102ⱼ can, for example, be uploaded onto computerized mobile communication device 401 by either Backend Ad management Server 100, or game developer framework 200 via a cellular connection, or wireless connection, and installed in the Game App 300q via API 120. For example, API 120 resides within Backend Ad management Server 100 as add-on component 120.

It is noted, that the ad may be at least one of: audio, video, graphic, pictorial, text, music and other forms, and may be provided in combinations with one another as well as synchronized with one another

Accordingly and in an embodiment, provided herein is a method for maximizing a player's emotional targeting of in-game advertisement in a computerized mobile communication device, implemented in a computerized system comprising: the computerized mobile communication device in communication with a network, a game development framework with an add-on program configured to enable addition and location of a remotely stored advertising, in real time into the game; a game application in communication with the development framework, having an advertising media player, the game application and advertising media player configured to be executed in the computerized mobile communication device, wherein the game application is in communication with the game development framework; and a backend advertising management server in communication with the game application and the remotely stored advertising, the method comprising: establishing a player profile; based on the player profile, in real time, determining an advertisement to be presented; through a network and using the backend advertising management server, retrieving the remotely stored advertising to be presented; delivering the advertising to the advertising media player; based on an emotional target event in the game, locating in real-time an object configured to display the advertising to be presented; and upon occurring of the emotional target event, using the advertising media player, displaying the advertisement on the object.

In an embodiment, using a game app 300_{q}, end users (gamers, or game players) can log on to game app 300_{q} and synchronize with the Game App 300_{q} server (see e.g., 250, FIG. 2) and Backend Ad management Server 100 through network 600. In an embodiment, the term “synchronized” refer to transfer of timing information and files or content so that computerized mobile communication device (see e.g., 401, 402, 403, 404, FIG. 2) are “synchronized” with respect to the information or content to be delivered (i.e., each mobile device has access to all of the files or multimedia content to be retrieved), and the timing of the in-game, on-screen display of the product or services offered for sale. The files/content being played back can include streaming media, etc. The term “playback data” is sometimes used herein to refer to such files and/or content.

Gamer profile can be obtained and be based on at least one of: gender, age, computerized mobile communication device type (e.g., iOS, Android), operating system version, search history, other apps on computerized mobile communication device(s) 401, 402, 403, 404, previously viewed ads, preference indication and the like.

Furthermore, the objects used to display the ads can be, for example at least one of: billboards, building walls, concrete fences and barriers, roads, and the like. In an embodiment, the object can be any quadrilateral surface in the game. It is noted that in an embodiment, the billboards are rounded rectangles, positioned selectably (in other words, “on-the fly”, by the game development framework, in real time and based on the emotional targeting event). The terms “user”, “game player”, gamer, “customer”, “consumer” and formatives thereof as utilized herein refer to any party desiring to initiate interaction with an app, information/support service accessible by the methods and systems described herein.

A clarification of the term “framework” as used herein is in order. Frameworks are predefined structures for objects, combinations of objects which form more extensive objects and eventually combinations which provide whole programs, such as the whole game app 300_{q}. Frameworks can be employed in which predefined, interconnected classes are organized to provide a structure that is the basis for creating a program. In Java, a framework is present that contains predefined classes used as base classes. Objects may be incorporated into these base classes or objects or combinations of objects. The game development framework can be a gaming server and communication module maintained by the game development company.

In an embodiment, the emotional target event to which a selectable ad is delivered once the event occurs, can be at least one of a rescue point, a reward point, a stage-end point, and a completion point. Furthermore, the reward-associated emotional target event is at least one of a cut-scene, a high personal score, a stage completion, and a game completion. It is noted, that under certain circumstances, the emotional targeting event can be a loss, such as at least one of; a crash, an item loss, and a game reset.

The computerized mobile communication device (see e.g., 401, 402, 403, 404, FIG. 2), may be various types of devices including a mobile phone, a laptop, or a touch screen device or computer. Additionally, a local area network (LAN) may also be incorporated into the system. The local area network may be in communication with a wireless network router. The local area network may be a wireless local area network.

In an embodiment, the game app (300_{q}) in each of the plurality of computerized mobile communication device can include a game controller comprising a central processing unit (CPU) that is microprocessor or software ore firmware based. The controller can perform various functions including controlling the screen display, as well as being in communication with a user interface (UI). The user interface may be one or a combination of different types of user interfaces depending upon the device. Many tablet computers include push-buttons or touch screens or both. Keyboards, styluses and other types of input devices may also be used as a user interface of the second-screen device. The user interface can be used to provide various inputs and responses to elements displayed on the (second) screen display. When the user interface is a touch screen or touch display, the screen display and the user interface may be one in the same. More than one user interface may be incorporated into the second screen device.

A memory component can also be in communication with the controller. The memory component may include different types of memory that store different types of data. The memory component may store operating software for the game app, operating data, user settings, video, music, documents, and add-on(s). The game application(s) 300_{q} may perform various functions, including an application for communicating with a Backend Ad management Server 100 illustrated in FIG. 1 and obtaining data from Backend Ad management Server 100 and any content management server. The application may allow computerized mobile communication device 401, 402, 402, 404 to communicate directly with Backend Ad management Server 100, or with game development framework 200ₚ.

A web interface may also be used for communicating with Backend Ad management Server 100 and/or game development framework 200ₚ. The web interface may allow a connection to the wide area network (e.g., the internet). The web interface may allow communication through a wireless network such as a local area network, a wide area network or a mobile or cellular network.

An interface component of the portal (in other words, the home page of the web interface) accessed when using the systems and methods described, can be configured to connect to and retrieve requested data from Backend Ad management Server 100 (in other words, the ad database main server). An end-user interface component, with the end-user and/or user-specific data having an internal content representation that correlates to an external appearance in a plurality of content option. The end-user interface and/or user-specific data can be stored on gaming server 250 (see e.g., FIG. 2) can incorporate the requested data retrieved from Backend Ad management Server 100 system into a current view in computerized mobile communication device 401, 402, 402, 404 display means. The user-specific data stored in an embodiment on gaming server 250 can be coupled to the end-user dedicated interface and likewise, user-specific data stored in an embodiment on gaming server 250 can be coupled to another end-user dedicated interface. The end-user interface can be configured to retrieve requested ad (e.g., as determined by Backend Ad management Server 100, based on the placement determined by game development framework 200ₚ server) incorporated into the user-specific data stored in an embodiment on gaming server 250 and to display the retrieved ad as one or more content items, in real time, on the fly in the game.

The term Backend Ad management Server 100, can be configured to operate as a content management server. “Content management server” or “gaming server 250” refers to a back-end hardware and software product that is used to manage content. Further, the term “dedicated interface” refers to information or content items displayed within a region of a portal web site or a specific location in the game application.

The servers (e.g., gaming server 250, FIG. 2) can process requests for page content in two phases, an “action” phase and a “render” phase, in that order. In the action phase, all invoked dedicated add-on in the game app can be configured to process the request (e.g., upon prompting of an emotional targeting event, but do not necessarily generate content. For particular requests it may be that the action phase is omitted, or may be invoked on a subset of the dedicated add-on(s) (in other words, sub-menus) or on a single dedicated add-on. In the render phase, the invoked dedicated add-on(s) contribute its (their) respective shards of executable commands to a (dedicated) game player engine that generates media in response to the original prompt on the end-users' display means (e.g., computerized mobile communication device 401, 402, 402, 404). This media is then sent to the requesting ad player 102ⱼ for streaming on the object determined to be the most effective for user engagement upon occurrence of the emotional targeting event.

This streaming can take place through a load balancer. The load balancer can be a network node that may include a processor or a computer coupled to the network and that communicates with other processors on the network including clients and servers. A load balancer may be a separate node or may be incorporated into another node such as, for example, a server. A node refers to any device coupled to the network including clients, caches, proxies, and servers. A “data center” refers to a group of at least two servers (see e.g., database servers FIG. 2) and may include a load balancer.

In addition, routines such as allowing access to the ad database, or among user-specific data stored in an embodiment on gaming server 250 can be restricted to Backend Ad management Server 100 and systems.

The systems described herein, for implementing the methods provided herein, can further comprise an administrative client device and a business client device in communication with Backend Ad management Server 100. In an embodiment, the term “server” refers to the process that provides the service, or the host computer on which the process operates. Similarly, the term “client”, or “client device” refers in another embodiment to the process or device that makes the request, or the host computer/device on which the process operates. As used herein, the terms “client” and “server” can refer to the processes, rather than the host computers, unless otherwise clear from the context. In addition, the process performed by a server can be broken up to run as multiple processes on multiple hosts (sometimes called tiers) for reasons that include reliability, scalability, security and redundancy, among others.

Accordingly, provided herein is a non-transitory computer readable storage medium having stored thereon processor-executable software instructions configured to cause a processor, when executed, to perform the operations associated with the method disclosed and claimed. The term “computer-readable medium” as used herein refers to any medium that participates in providing information to the processor, including instructions for execution. Such a medium may take many forms, including, but not limited to computer-readable storage medium (e.g., non-volatile media, volatile media), and transmission media. Non-transitory media, such as non-volatile media, include, for example, optical or magnetic disks. Volatile media include, for example, dynamic memory.

Transmission media include, for example, twisted pair cables, coaxial cables, copper wire, fiber optic cables, and carrier waves that travel through space without wires or cables, such as acoustic waves and electromagnetic waves, including radio, optical and infrared waves. Signals include man-made transient variations in amplitude, frequency, phase, polarization or other physical properties transmitted through the transmission media.

Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, an EPROM, a FLASH-EPROM, an EEPROM, a flash memory, any other memory chip or cartridge, a carrier wave, or any other medium from which a computer can read. The term computer-readable storage medium is used herein to refer to any computer-readable medium except transmission media.

All ranges disclosed herein are inclusive of the endpoints, and the endpoints are independently combinable with each other. Furthermore, the terms “first,” “second,” and the like, herein do not denote any order, quantity, or importance, but rather are used to denote one element from another. The terms “a”, “an” and “the” herein do not denote a limitation of quantity, and are to be construed to cover both the singular and the plural, unless otherwise indicated herein or clearly contradicted by context. The suffix “(s)” as used herein is intended to include both the singular and the plural of the term that it modifies, thereby including one or more of that term (e.g., the user(s) includes one or more user). Reference throughout the specification to “one embodiment”, “another embodiment”, “an embodiment”, and so forth, means that a particular element (e.g., feature, structure, and/or characteristic) described in connection with the embodiment is included in at least one embodiment described herein, and may or may not be present in other embodiments. In addition, it is to be understood that the described elements may be combined in any suitable manner in the various embodiments.

The term “plurality”, as used herein, is defined as two or as more than two. The term “another”, as used herein, is defined as at least a second or more. The terms “including” and/or “having”, as used herein, are defined as comprising (i.e., open language).

The term “communication” and its derivatives (e.g., “in communication”) may refer to a shared bus configured to allow communication between two or more devices, or to a point to point communication link configured to allow communication between only two (device) points. Likewise, the term “operatively coupled” or “operably coupled” refers to a connection between devices or portions thereof that enables operation in accordance with the present system. For example, an operative coupling may include one or more of a wired connection and/or a wireless connection between two or more devices that enables a one and/or two-way communication path between the devices or portions thereof. In addition, an operable coupling may include a communication path through a wired and/or wireless network, such as a connection utilizing the Internet. The term contact center is utilized herein to describe a support/service center and as such, may be a contact center, call center, etc.

While particular embodiments have been described, alternatives, modifications, variations, improvements, and substantial equivalents that are or may be presently unforeseen may arise to applicants or others skilled in the art. Accordingly, the appended claims as filed and as they may be amended, are intended to embrace all such alternatives, modifications variations, improvements, and substantial equivalents.

What is claimed is:

1. A method for maximizing a player's emotional targeting of in-game advertisement in a computerized mobile communication device, implemented in a computerized system comprising:
the computerized mobile communication device in communication with a network,
a game development framework with an add-on program configured to enable addition and location of a remotely stored advertising, in real time into the game;
a game application in communication with the development framework, having an advertising media player, the game application and advertising media player configured to be executed in the computerized mobile communication device, wherein the game application is in communication with the game development framework;
and a backend advertising management server in communication with the game application and the remotely stored advertising,
the method comprising:
a. establishing a player profile;
b. based on the player profile, in real time, determining an advertisement to be presented;
c. through a network and using the backend advertising management server, retrieving the remotely stored advertising to be presented;
d. delivering the advertising to the advertising media player;
e. based on an emotional target event in the game, locating in real-time an object configured to display the advertising to be presented; and
f. upon occurring of the emotional target event, using the advertising media player, displaying the advertisement on the object.

2. The method of claim 1, wherein the object is a billboard.

3. The method of claim 2, wherein the billboard has rounded corners.

4. The method of claim 1, wherein the object is a quadrilateral surface.

5. The method of claim 4, wherein the advertising media player is further configured to adapt the advertising frame to the quadrilateral surface.

6. The method of claim 1, wherein the emotional target event is at least one of a rescue point, a reward point, a stage-end point, and a completion point.

7. The method of claim 1, wherein the advertising media player further comprises an add on program configured to, when executed cause a process to play the advertising displayed, monitor viewing of the advertisement, report the event to at least one of the game developer framework and the backend advertising management server.

8. The method of claim 7, wherein the backend advertising management server further comprises an application programming interface (API).

9. The method of claim 8, wherein the API is configured to deliver the uploaded advertising delivered into the advertising media player, provide usage statistics, or their combination.

10. The method of claim 1, wherein the add on program of the game developer framework is further configured to, when executed, cause a processor:
a. wirelessly connect with the computerized mobile communication device;
b. control an operation of the game on the computerized mobile communication device;
c. access game progress files stored on the computerized mobile communication device; and
d. perform machine learning to discern a player-specific emotional target event engagement rate.

11. The method of claim 10, wherein the player-specific emotional target event engagement rate is determined based on at least one of rate of movement of the computerized mobile communication device, pressure on the computerized mobile communication device, eyeball tracking, and heartrate.

12. The method of claim 6, wherein the reward-associated emotional target event is at least one of a cut-scene, a high personal score, a stage completion, and a game completion.

13. The method of claim 12, wherein the emotional target event is associated with loss.

14. The method of claim 13, wherein the loss is a crash, an item loss, and a game reset.
